(19) United States
(12) Patent Application Publication
(10) Pub. No.: US 2009/0042643 A1
(43) Pub. Date: Feb. 12, 2009

(54) Wagering Game System With Progressive-Award Denomination Selection Feature

(75) Inventors: Mark B. Gagner, West Chicago, IL (US); Alfred Thomas, Las Vegas, NV (US)

Correspondence Address: NIXON PEABODY LLP, 161 N CLARK ST., 48TH FLOOR, CHICAGO, IL, 60601-3213, US

(73) Assignee: WMS GAMING INC., Waukegan, IL (US)

(21) Appl. No.: 11/663,381

(22) PCT Filed: Sep. 29, 2005
(86) PCT No.: PCT/US05/34856

§ 371 Date: Mar. 21, 2007

Related U.S. Application Data
(60) Provisional application No. 60/614,248, filed on Sep. 29, 2004.

(51) Int. Cl. A63F 9/24; A63F 13/00

(52) U.S. Cl. 463/27

(57) ABSTRACT

A gaming system comprising a plurality of gaming terminals and a progressive-game controller. Each gaming terminal has a wagering game with a plurality of symbols that indicate a randomly selected outcome elected from a plurality of outcomes, and the wagering game allows a player to be eligible for a progressive game jackpot. The gaming terminals include terminals having different payout demonimantions. The progressive-game controller is coupled to the gaming terminals and operative to (i) receive information from each of the gaming terminals, wherein the information includes the payout denominations available at the gaming terminals, and (ii) determine a progressive-award denomination based on the information received from the gaming terminals. An escrow pool may be established to assist in paying a progressive jackpot if the denomination-selection feature results in a jackpot-award value that is greater than the actual value of the jackpot.

### FIELD OF THE INVENTION

The present invention relates generally to a gaming system and, more particularly, to a gaming system having a progressive game with a feature for selecting the denomination of the award.

### BACKGROUND OF THE INVENTION

Gaming machines, such as slot machines, video poker machines, and the like, have been a cornerstone of the gaming industry for several years. Generally, the popularity of such machines with players is dependent on the likelihood (or perceived likelihood) of winning money at the machine and the intrinsic entertainment value of the machine relative to other available gaming options. Where the available gaming options include a number of competing machines and the expectation of winning each machine is roughly the same (or believed to be the same), players are most likely to be attracted to the most entertaining and exciting of the machines.

Consequently, shrewd operators strive to employ the most entertaining and exciting machines available because such machines attract frequent play and, hence, increase profitability to the operator. In the competitive gaming machine industry, there is a continuing need for gaming machine manufacturers to produce new types of games, or enhancements to existing games, which will attract frequent play by enhancing the entertainment value and excitement associated with the game.

One concept that has been successfully employed to enhance the entertainment value of a game is that of a “bonus” game which may be played in conjunction with a “basic” game. The bonus game may comprise any type of game, either similar to or completely different from the basic game, and is entered upon the occurrence of a selected event or outcome of the basic game. Such a bonus game produces a significantly higher level of player excitement than the basic game because it provides a greater expectation of winning than the basic game.

Another concept that has been employed is the use of a progressive jackpot. In the gaming industry, a “progressive” involves collecting coin-in data from participating gaming device(s) (e.g., slot machines), contributing a percentage of that coin-in data to a jackpot amount, and awarding that jackpot amount to a player upon the occurrence of a certain jackpot-won event. The percentage of the coin-in is determined prior to any result being achieved and is independent of any result. A jackpot-won event typically occurs when a “progressive winning position” is achieved at a participating gaming device. If the gaming device is a slot machine, a progressive winning position may, for example, correspond to alignment of progressive jackpot reel symbols along a certain payline. The initial progressive jackpot is a predetermined minimum amount. That jackpot amount, however, progressively increases as players continue to play the gaming machine without winning the jackpot. Further, when several gaming machines are linked together such that several players at several gaming machines compete for the same jackpot, the jackpot progressively increases at a much faster rate, which leads to further player excitement.

As progressive jackpot games become more advanced, there is a need to group different types of gaming terminals into the same progressive game. However, these different terminals often receive wager inputs and make payouts in different denominations (e.g., nickel games, quarter games, dollar games). Thus, there is a need for a feature for a progressive game that allows for the control and the selection of the progressive-award denomination to be used when awarding a progressive jackpot at the different terminals participating in the progressive game.

### SUMMARY OF THE INVENTION

The present invention solves the aforementioned problems by creating a selection feature that allows for the selection of the progressive-award denomination when the plurality of gaming terminals competing for the progressive jackpot have different payout denominations. In the preferred embodiment, the selection automatically occurs through the use of a progressive-game controller that is linked to the plurality of gaming terminals.

Specifically, the present invention involves a method for playing a progressive game at a plurality of gaming terminals. The progressive game allows a player to be eligible for a progressive jackpot. The method comprises, prior to conducting the progressive game, establishing a progressive-award denomination for the progressive game after receiving information regarding payout denominations available at each of the plurality of gaming terminals, wherein the plurality of gaming terminals include gaming terminals having different payout denominations. The method further comprises establishing an escrow pool to assist in paying the progressive jackpot if the progressive jackpot results in an award value that is greater that the actual value of the jackpot due to the rounding-up from the denomination selection feature.

In another aspect, the present invention involves a method for establishing a progressive-award denomination for a progressive jackpot in a gaming system having a plurality of gaming terminals with different payout denominations. Each of the gaming terminals allows a player to be eligible for the progressive jackpot. The method comprises receiving signals from the plurality of gaming terminals indicating a payout denomination at each of the plurality of gaming terminals, and establishing a maximum payout denomination that is available at one or more of the plurality of gaming terminals. Thereafter, the method includes determining whether each of the payout denominations from the plurality of gaming terminals is equally divisible (i.e., results in an integer) into the maximum payout denomination and, if the answer to the determining step is positive, setting the progressive-award denomination at a value that is equal to the maximum payout denomination. On the other hand, if the answer to determining step is negative, the method again performs the determining step with the next increment of the maximum payout denomination and, if the answer is positive, the progressive-award denomination is set at a value equal to that next increment of the maximum payout denomination. The method can then cycle through multiple increments before the progressive-award denomination is established.

In a further aspect of the invention, the present invention is a gaming system, comprising a plurality of gaming terminals and a progressive-game controller. Each of the plurality of gaming terminals has a wagering game with a plurality of symbols that indicate a randomly selected outcome selected from a plurality of outcomes, and the wagering game allows a player to be eligible for a progressive jackpot. The plurality of gaming terminals include gaming terminals having different payout denominations. The progressive-game controller is coupled to the plurality of gaming terminals and operative to (i) receive information from each of the plurality of gaming terminals, wherein the information includes the payout denominations available at the gaming terminals, and (ii) determine a progressive-award denomination based on the information received from the plurality of gaming terminals.

The above summary of the present invention is not intended to represent each embodiment or every aspect of the present invention. The detailed description and Figures will describe many of the embodiments and aspects of the present invention.

### BRIEF DESCRIPTION OF THE DRAWINGS

The foregoing and other advantages of the invention will become apparent upon reading the following detailed description and upon reference to the drawings.

FIG. 1 is a perspective view of a video gaming terminal according to one embodiment of the present invention.

FIG. 2 is a block diagram of the gaming terminal of FIG. 1.

FIG. 3 illustrates a display of a basic game on the gaming terminal of FIG. 1.

FIG. 4 illustrates a system for a progressive wagering game.

FIG. 5 is a flow diagram showing the establishing of an escrow pool that is used in accordance with one embodiment of the present invention.

FIG. 6 is a flow diagram showing the establishing the denomination of the progressive award according to one embodiment of the present invention.

While the invention is susceptible to various modifications and alternative forms, specific embodiments have been shown by way of example in the drawings and will be described in detail herein. It should be understood, however, that the invention is not intended to be limited to the particular forms disclosed. Rather, the invention is to cover all modifications, equivalents, and alternatives falling within the spirit and scope of the invention as defined by the appended claims.

### DESCRIPTION OF ILLUSTRATIVE EMBODIMENTS

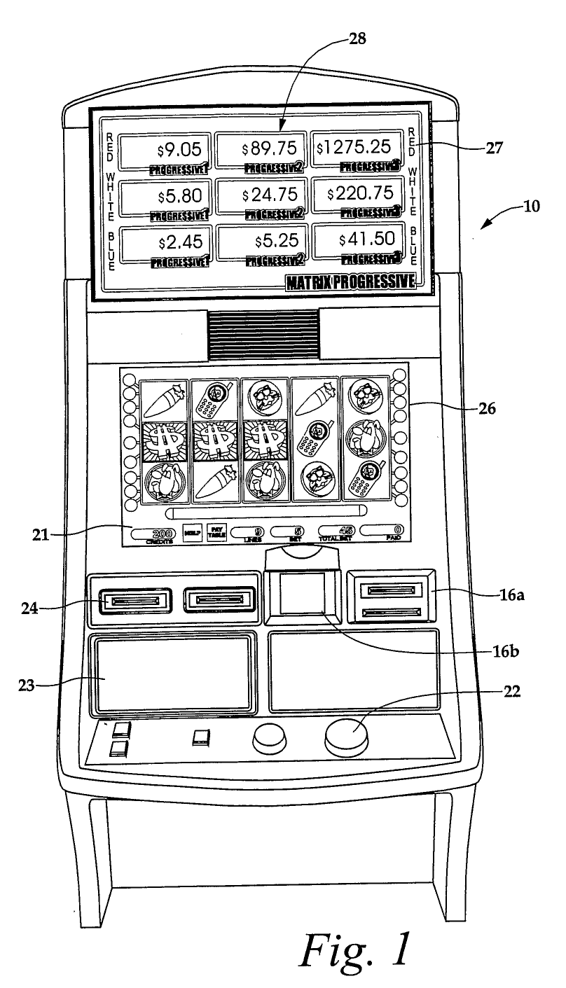

FIG. 1 shows a perspective view of a typical gaming terminal 10 used by gaming establishments, such as casinos. With regard to the present invention, the gaming terminal 10 may be any type of gaming terminal and may have varying structures and methods of operation. For example, the gaming terminal 10 may be a mechanical gaming terminal configured to play mechanical slots, or it may be an electromechanical or electrical gaming terminal configured to play video slots or a video casino game, such as blackjack, slots, keno, poker, etc.

As shown, the gaming terminal 10 includes input devices, such as a wager acceptor 16 (shown as a card wager acceptor 16a and a cash wager accepter 16b), a touch screen 21, a push-button panel 22, and an information reader 24. For outputs, the gaming terminal 10 includes a payout mechanism 23, a main display 26 for displaying information about the basic wagering game, and a secondary display 27 that may display an electronic version of a pay table, and/or also possibly game-related information or other entertainment features. In this embodiment, the secondary display 27 displays a progressive jackpot array 28 (or matrix). While these typical components found in the gaming terminal 10 are described below, it should be understood that numerous other elements may exist and may be used in any number of combinations to create various forms of a gaming terminal.

The wager acceptor 16 may be provided in many forms, individually or in combination. The cash wager acceptor 16a may include a coin slot acceptor or a note acceptor to input value to the gaming terminal 10. The card wager acceptor 16b may include a card-reading device for reading a card that has a recorded monetary value with which it is associated. The card wager acceptor 16b may also receive a card that authorizes access to a central account, which can transfer money to the gaming terminal 10.

Also included is the payout mechanism 23, which performs the reverse functions of the wager acceptor. For example, the payout mechanism 23 may include a coin dispenser or a note dispenser to output value from gaming terminal 10. Also, the payout mechanism 23 may also be adapted to receive a card that authorizes the gaming terminal to transfer credits from the gaming terminal 10 to a central account.

The push button panel 22 is typically offered, in addition to the touch screen 21, to provide players with an option on how to make their game selections. Alternatively, the push button panel 22 provides inputs for one aspect of operating the game, while the touch screen 21 allows for inputs needed for another aspect of operating the game.

The outcome of the basic wagering game is displayed to the player on the main display 26. The main display 26 may take the form of a cathode ray tube (CRT), a high resolution LCD, a plasma display, LED, or any other type of video display suitable for use in the gaming terminal 10. As shown, the main display 26 includes the touch screen 21 overlaying the entire monitor (or a portion thereof) to allow players to make game-related selections. Alternatively, the gaming terminal 10 may have a number of mechanical reels to display the game outcome, as well.

In some embodiments, the information reader 24 is a card reader that allows for identification of a player by reading a card with information indicating his or her true identity. Currently, identification is used by casinos for rewarding certain players with complimentary services or special offers. For example, a player may be enrolled in the gaming establishment's players' club and may be awarded certain complimentary services as that player collects points in his or her player-tracking account. The player inserts his or her card into the information reader 24, which allows the casino's computers to register that player's wagering at the gaming terminal 10. The information reader 24 may also include a keypad (not shown) for entering a personal identification number (PIN). The gaming terminal 10 may require that the player enter their PIN prior to obtaining information. The gaming terminal 10 may use the secondary display 27 for providing the player with information about his or her account or other player-specific information. Also, in some embodiments, the information reader 24 may be used to restore assets that the player achieved during a previous game session and had saved.

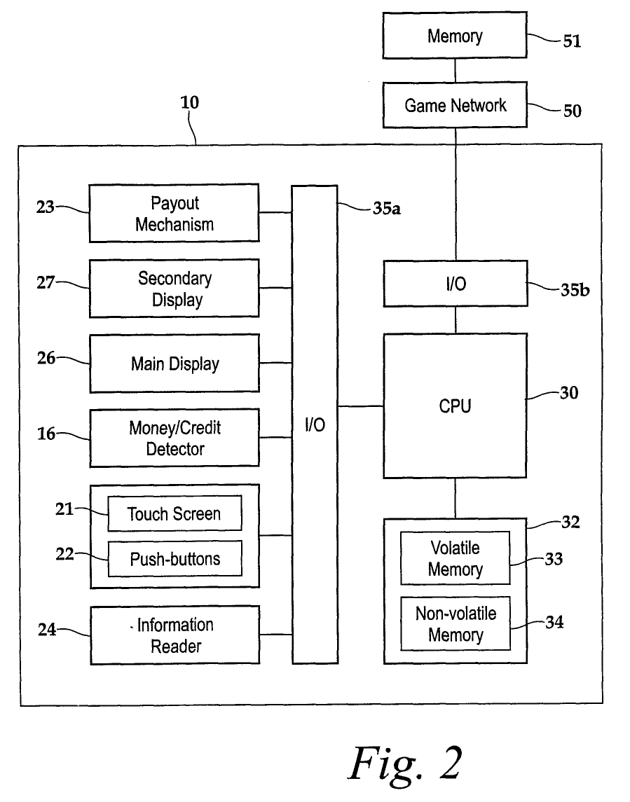

As shown in FIG. 2, the various components of the gaming terminal 10 are controlled by a central processing unit (CPU) 30 (such as a microprocessor or microcontroller). To provide the gaming functions, the CPU 30 executes a game program that allows for the randomly selected outcome. The CPU 30 is also coupled to or includes a local memory 32. The local memory 32 may comprise a volatile memory 33 (e.g., a random-access memory (RAM)) and a non-volatile memory 34 (e.g., an EEPROM). It should be appreciated that the CPU 30 may include one or more microprocessors. Similarly, the local memory 32 may include multiple RAM and multiple program memories.

Communications between the peripheral components of the gaming terminal 10 and the CPU 30 occur through input/output (I/O) circuits 35a. As such, the CPU 30 also controls and receives inputs from the peripheral of the gaming terminal 10. Further, the CPU 30 communicates with external systems via the I/O circuits 35b. Although the I/O circuits 35 may be shown as a single block, it should be appreciated that the I/O circuits 35 may include a number of different types of I/O circuits.

It should be noted that the operation of the gaming terminal 10 can be controlled by a controller within the game network 50. As such, after receiving a wager at the gaming terminal 10, the random selection of the outcome occurs within the network 50. The network 50 then communicates the random outcome to the gaming terminal 10, which then displays symbols indicative of that outcome. In this alternative, the gaming terminal 10 is used for receiving inputs from the player and displaying outputs to the player. The game network 50 can be used to operate certain games, such as bonus games or progressive games that are contributed to by all or some of the gaming terminals 10 in the game network 50 (e.g., terminal-level jackpots that only each gaming terminal 10 contributes to, bank-level jackpots that are contributed to by all of the gaming terminals 10 in a particular bank, and wide-area jackpots that are contributed to by a larger number of gaming terminals 10, such as multiple banks). The gaming network 50 may have a system memory 51 that is used for performing some or all of these functions.

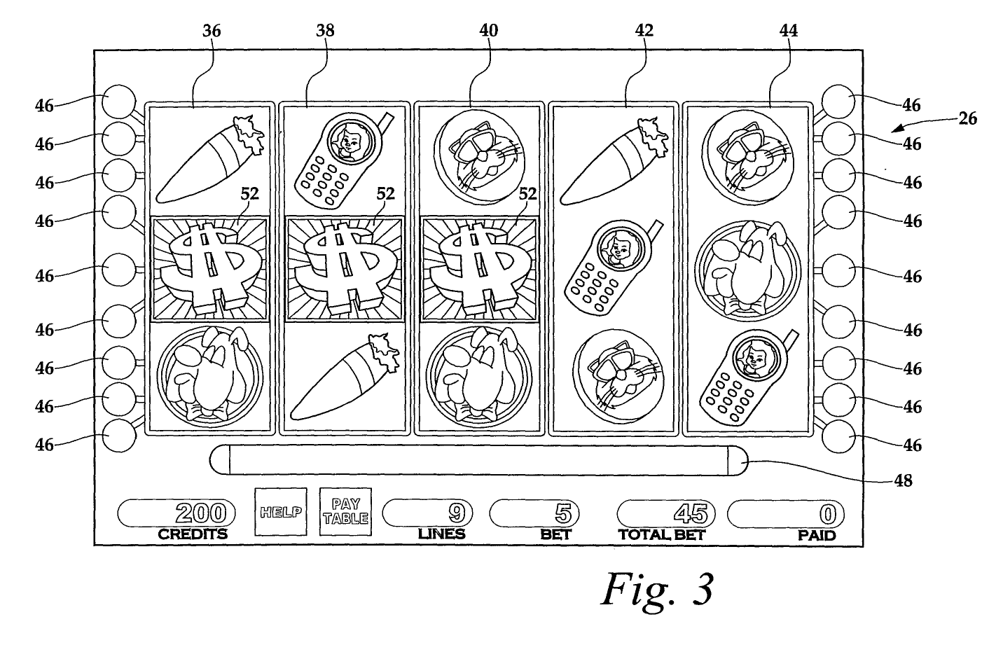

Turning now to FIG. 3, the main display 26 of one embodiment of the present invention is shown in more detail. In this embodiment, the basic wagering game is a slot machine game, with symbols on five different reels 36, 38, 40, 42, 44. The reels 36-44 may be either traditional mechanical reels or they may be computer-generated images of reels, with each reel including a plurality of symbols. The payline indicators 46 indicate a randomly selected outcome for each payline, which is the combination of symbols on the reels 36-44. Thereafter, an outcome indicator 48 indicates whether the outcome has resulted in a winning outcome or a non-winning outcome. In the present example, various combinations of the symbols can result in winning outcomes, which include monetary and non-monetary prizes. The non-monetary prizes can include free spins, multipliers, and entry into an advanced game such as bonus game or a progressive game. While nine pay lines 46 are shown, a gaming terminal 10 with a single payline will also work with the present invention.

In this particular embodiment, a particular group of symbols 52 indicates that the player has achieved one of the progressive-jackpot outcomes. In this embodiment, a combination of three dollar signs along an active payline indicates the progressive-jackpot outcome. In other embodiments, all award-winning combinations generate the progressive-jackpot outcome 52 or a single particular symbol may generate the progressive-jackpot outcome 52.

The progressive-jackpot outcome 52 corresponds to the progressive jackpot array (or matrix) 28 illustrated on the secondary display 27 in FIG. 1. Generally speaking, in each of the figures, the progressive jackpot array 28 includes nine different progressive jackpots. The columns in the array 28 are indicated by progressive numbers (e.g., progressive 1, progressive 2, progressive 3) and the rows are indicated by colors (e.g., red, white, and blue). The progressive jackpots are initially created by a base amount that is reset after the progressive jackpot is won. The progressive jackpot is then increased by a portion of the wager inputs from players competing for the progressive jackpots. The amount added to the progressive jackpot can be a fixed percentage of each wager input, a variable percentage of each wager input, or dictated by the symbol combination of the basic game shown in FIG. 3.

The displayed value of the progressive jackpots can be incremented in various denominations in accordance with the present invention. For example, the displayed values of the Progressive 2 and Progressive 3 columns are incremented and equally divisible by $0.25 (i.e., a quarter), but the award values are incremented in units of $1.00 (i.e., a dollar). But, the displayed values of the Progressive 1 column can be incremented in nickels, while the award values can also be in dollars. Hence, winning any of the progressive jackpots in the Progressive 1, the Progressive 2, and Progressive 3 columns will result in an award value that is rounded-up from the displayed value to the next dollar. It should be noted that the actual values of the progressive jackpots may be slightly more or less than the displayed values.

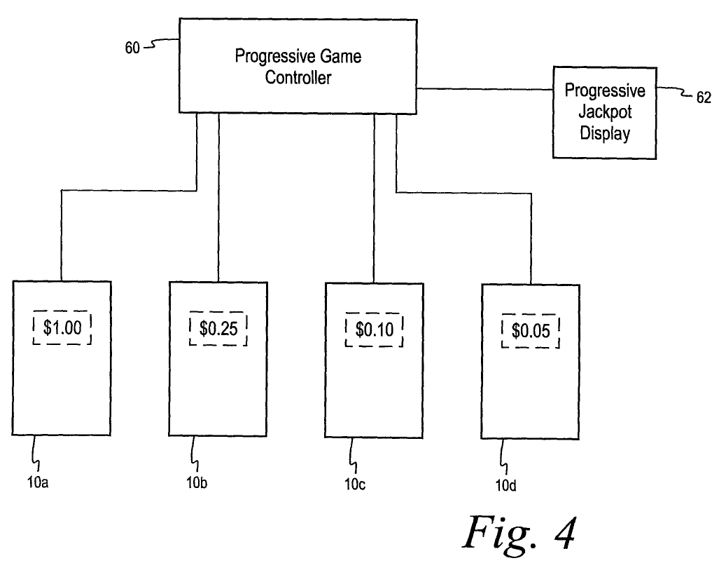

FIG. 4 describes a progressive game system that includes a progressive-game controller 60, which is linked to a plurality of gaming terminals 10a-10d. Each of the plurality of gaming terminals 10a-10d receives wagers and awards payouts in different denominations. The amounts of the denominations at each of the gaming terminals 10a-10d is exemplary and the present invention is useful with gaming terminals of other denominations. The progressive-game controller 60 also may be linked to a progressive jackpot display 62, which provides information to the players at the gaming terminals 10a-10d regarding the amount of the jackpots for the progressive games being played. The progressive jackpot display 62 is typically adjacent to the gaming terminals 10. It should be noted that the progressive-game controller 60 can be a part of the gaming network 50 in FIG. 2, or can be distinct from the gaming network 50.

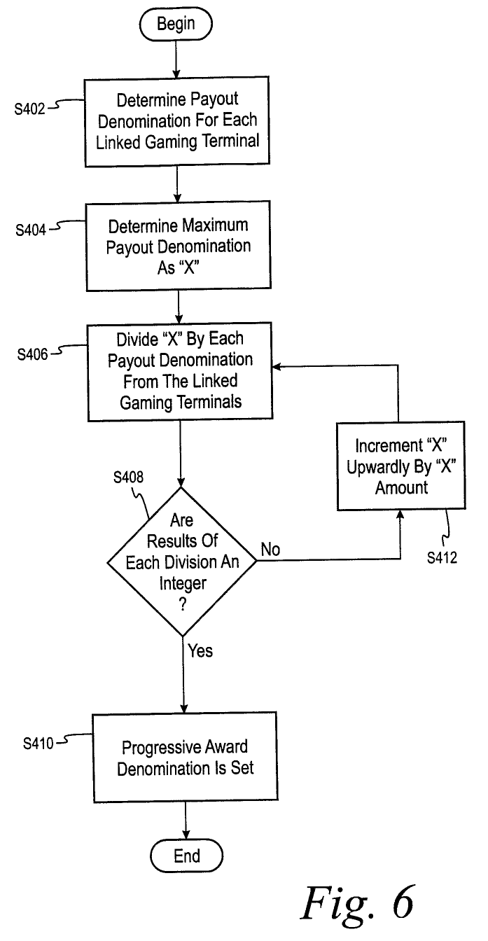

In the preferred embodiment, the progressive-game controller 60 is used to determine the denomination that will be awarded for the progressive jackpot or jackpots that are available at the gaming terminals 10a-10d. The progressive-game controller 60 may interrogate each of the gaming terminals 10a-10d to determine what types of denominations are being used at the gaming terminals 10a-10d participating in the progressive game(s). Accordingly, the progressive-game controller 60 can perform this interrogation when the progressive game is established and the link or links are made to the gaming terminals 10a-10d. Further, the interrogation may occur when any new gaming terminal 10 is added to the progressive game system. The manner in which the progressive-game controller 60 determines the denomination of the progressive jackpot or jackpots is discussed further with respect to FIG. 6.

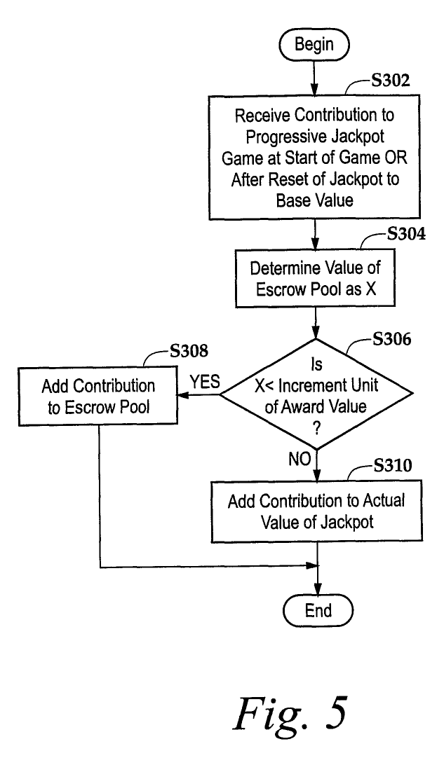

FIG. 5 describes a process by which an escrow pool is created to allow for the rounding-up of any award value of jackpots. The escrow pool can be created by the progressive-game controller 60 of FIG. 4. For this example in FIG. 5, it is assumed that the displayed value is substantially equal to the actual value of the progressive jackpot. In many situations, the portions of wagers inputs that are contributed to the progressive game are less than $0.01, such that the jackpot has an actual value that includes a fraction of $0.01 and, hence, is substantially equal to the displayed value. At step S302, the contribution to a progressive jackpot is received. The value of the escrow pool (“X”) is then determined at step S304. If the value of the escrow pool is less than the increment unit of the award value (the increment unit being the denomination of the award developed with respect to FIG. 6) i.e., an answer of YES at step S304, then the contribution is added to the escrow pool at step S308 to increase its value. If the answer is NO at step S306, then the contribution is made to the actual value of the jackpot as shown in step S308. The end result of FIG. 5 is a process by which the escrow pool allows for the awarding of more of an award (i.e., rounding up) than the actual jackpot that is displayed to the players.

As an example, if the progressive game is payable in a $1.00 denomination, then this process allows the displayed value to be in an increment less than or equal to $1.00 (e.g., pennies, nickels, dimes, quarters). If the progressive award is achieved, then the award value of the jackpot is rounded up from the displayed value to the next dollar. More specifically, when a player achieves the progressive jackpot, the difference between an award value of $12.00 and the actual value (and perhaps the displayed value) of $11.19, which is $0.81, is then reduced from the escrow pool of $1.00. Hence, the escrow pool starts the next progressive game session with a value of $0.19 and receives the initial contributions until its value is reestablished at $1.00. While the escrow pool is being established to the desired level, the displayed value of the progressive jackpot typically remains constant at its reset level.

The escrow pool concept of FIG. 5 can be used with a plurality of progressive jackpots, such as those shown in FIG. 1. The escrow can be established as the sum of all possible differences between the displayed value and the award value. For example, if the progressive system pays an award value only in $1.00 denominations, then the nine jackpots of FIG. 1, which could be achieved simultaneously by one or more players, would require an escrow pool of $9.00 (9×$1.00). Alternatively, the winning of multiple progressives by one individual could result in the summing of the displayed values of the individual progressive jackpots that are achieved, and the total amount of the displayed values could be increased via the escrow pool to the dollar increment. Thus, the escrow pool could be established at a lower value, perhaps as little as $1.00.

Further, the escrow pool could also be used to create extra movement in the displayed value at times when the displayed values is stagnant due to minimal player activity. This way, the players are provided with more excitement as the jackpots always seem to be increasing. Hence, the escrow pool could act as a buffer that allows for movement of the displayed values.

FIG. 6 describes a process by which the award denomination for the progressive jackpot is determined. At step S402, the progressive-game controller 60 determines a payout denomination for each of the gaming terminals 10a-10d that are linked to the progressive-game controller 60. Next, at step S404, the progressive-game controller 60 determines the maximum payout denomination for all of the link gaming terminals 10a-10d, as value “X”.

Once the value “X” has been established, the progressive-game controller 60 then divides the value “X” by each of the payout denominations at the gaming terminals 10-10d (step S406). If the value of each division is an integer, such that each gaming terminal 10 is able to pay any jackpot with the denominations associated with each of the gaming terminal 10 (step S408), then the progressive-award denomination is established that step S410. However, if the result of any of the divisions performed by the progressive-game controller 60 at step S408 is not an integer, then the value “X” is incremented upwardly by an amount equal to the value “X” at step S412. Accordingly, after the first unsuccessful attempt at the divisions performed by the progressive-game controller 60 at step S408, the value of “X” is increased to “2×.” The process then returns to step S406 wherein the division step is performed with the value of the numerator now being at “2×.” For each unsuccessful attempt at the division step S408 that is performed by the progressive-game controller 60 (i.e., yielding at least one value that is not an integer), the step S412 is repeated. Once one of the repeated division steps S408 is performed successfully, then the progressive-award denomination award is set at the value at which the division step was successful at step S410.

The process of FIG. 6 results in an award value that is higher than the actual value of the progressive jackpot due to a rounding-up process. The escrow pool of FIG. 5 is useful for providing funds to accommodate the difference between the award value of the progressive jackpot or jackpots, and the actual value of the progressive jackpot or jackpots.

In an alternative embodiment to FIG. 6, the progressive-game controller 60 determines the largest payout denomination that is available at each of the gaming terminals 10a-10d. The escrow pool mentioned with respect to FIG. 5 is then established at the value equal to the largest payout denomination. When one of the gaming terminals 10 awards a progressive jackpot, that gaming terminal 10 rounds up to the next denomination that is payable at that gaming terminal 10. Hence, it may be possible that a progressive jackpot has an award value at one gaming terminal 10 that is slightly different from the award value of a different gaming terminal 10.

In yet a further alternative, an operator provides inputs to the progressive-game controller 60 that assists in the determination of the denomination for the progressive game award. For example, an operator may choose a specific value (e.g., a certain denomination) that he or she believes is acceptable for an award of the progressive game. The progressive-game controller 60 can then perform the various steps within FIG. 6 (e.g. step S408) to determine whether the award chosen by the operator is acceptable. It is also possible to simply allow the operator to set the value without any analysis by the progressive-game controller 60 and the progressive-game controller 60 is simply used to implement the desire of the operator.

Further, it should be noted that while the present invention has been described with respect to a basic game triggering the progressive jackpot, the bonus or secondary game could be equally employed to perform this task. Furthermore, the determination of whether a player has achieved a progressive jackpot can be conducted by the gaming terminal 10 or by the progressive-game controller 60. For example, playing a wagering game (basic game or bonus game) may cause the player to be eligible for the progressive jackpots, and the controller 60 then determines whether the player has won. The progressive-game controller 60 may determine whether the player has won one or more of the jackpots in a “mystery” fashion such that the player is surprised that he or she has won. The progressive-game controller 60 may instruct the gaming terminal 10 of a progressive game outcome, and the gaming terminal 10 may then display symbols indicative of the progressive game outcome or, in the case of a mystery jackpot, the gaming terminal 10 may then award one or more of the progressive jackpots.

While the present invention has been described with reference to one or more particular embodiments, those skilled in the art will recognize that many changes may be made thereto without departing from the spirit and scope of the present invention. For example, the progressive-game controller 60 may be linked to hundreds of gaming terminals at several different casinos. Further, it should be noted that some of the gaming terminals 10 may provide a ticket printout as an award that provides an award value to the exact penny. Each of these embodiments and obvious variations thereof is contemplated as falling within the spirit and scope of the claimed invention, which is set forth in the following claims.

1. A method for establishing a progressive-award denomination for a progressive jackpot in a gaming system having a plurality of gaming terminals with different payout denominations, each of said gaming terminals allowing a player to be eligible for said progressive jackpot, said method comprising:
receiving signals from said plurality of gaming terminals indicating a payout denomination at each of said plurality of gaming terminals;
establishing a maximum payout denomination that is available at one or more of said plurality of gaming terminals;
determining whether each of said payout denominations from said plurality of gaming terminals is equally divisible into said maximum payout denomination; and
if the answer to said determining step is positive, setting said progressive-award denomination at a value that is equal to said maximum payout denomination.

2. The method of claim 1, further including, if the answer to said determining step is negative, establishing a modified maximum payout denomination that is equal to an increment of the value of said maximum payout denomination, and
evaluating whether each of said payout denominations from said plurality of gaming terminals is equally divisible into a modified maximum payout denomination; and
if the answer to said evaluating step is positive, setting said progressive award payout at a value that is equal to said modified maximum payout denomination.

3. (canceled)

4. (canceled)

5. The method of claim 1,
including operating said progressive game by receiving wager inputs from players at said plurality of gaming terminals and awarding said progressive jackpot to a player at one of said plurality of gaming terminals in response to said player achieving a progressive-jackpot outcome at said one of said plurality of gaming terminals, said progressive jackpot being paid in a denomination equal to said progressive-award denomination,
wherein said one of said plurality of gaming terminals has a payout denomination that is less than progressive-award denomination, and further including rounding-up an actual value of said progressive jackpot to a next increment of said progressive-award denomination by utilizing at least a portion of an escrow pool.

6. The method of claim 5, wherein said escrow pool is established by a portion of said wager inputs at said plurality of gaming terminals that is used for funding said progressive jackpot.

7. (canceled)

8. The method of claim 1, further including prior to said receiving step, sending a signal from said progressive-game controller to said plurality of gaming terminals requesting each of said gaming terminals to send payout denomination information.

9. (canceled)

10. A gaming system, comprising:
a plurality of gaming terminals each of which has a wagering game with a plurality of symbols that indicate a randomly selected outcome selected from a plurality of outcomes, said wagering game allowing a player to be eligible for a progressive jackpot, said plurality of gaming terminals including gaming terminals having different payout denominations; and
a progressive-game controller coupled to said plurality of gaming terminals and operative to:
receive information from each of said plurality of gaming terminals, said information including said payout denominations that are available at said plurality of gaming terminals; and
determine a progressive-award denomination based on said information received from said plurality of gaming terminals.

11. (canceled)

12. (canceled)

13. (canceled)

14. The gaming system of claim 10, wherein said progressive-game controller is further operative to conduct said progressive game by receiving a portion of wager inputs received at said plurality of gaming terminals;
wherein said progressive-game controller is further operative to award a progressive jackpot to a player at one of said plurality of gaming terminals in response to said player achieving a progressive-jackpot outcome in said wagering game, an award value of said progressive jackpot being in an increment of said progressive-award denomination; and
wherein said controller is further operative to create an escrow pool from a portion of said wager inputs and to use said escrow pool when said award value of said progressive jackpot is greater than an actual value of said progressive jackpot.

15. The gaming system of claim 10, wherein said controller is further operative to create an escrow pool from a portion of said wager inputs and to use said escrow pool when an award value of said progressive jackpot is greater than an actual value of said progressive jackpot.

16. The gaming system of claim 10, wherein said controller is further operative to send a signal to each of said plurality of gaming terminals instructing said gaming terminals to provide said information.

17. The gaming system of claim 10, wherein said progressive-award denomination is equal to a maximum payout denomination of said payout denominations that is available at one or more of said plurality of gaming terminals.

18. The gaming system of claim 10, wherein said progressive-award denomination is equal to an increment of a maximum payout denomination of said payout denominations that is available at one or more of said plurality of gaming terminals.

19. (canceled)

20. (canceled)

21. A method for playing a progressive game at a plurality of gaming terminals, said wagering game allowing a player to be eligible for a progressive jackpot, said method comprising:
prior to conducting said progressive game, receiving information from said plurality of gaming terminals indicating a payout denomination at each of said plurality of gaming terminals, said plurality of gaming terminals including gaming terminals having different payout denominations;
based on said information, establishing a progressive-award denomination;
conducting said wagering games at said plurality of gaming terminals in response to receiving wager inputs from players; and
in response to a player at one of said gaming terminals achieving a progressive award outcome, awarding said progressive jackpot to said player.

22. The method of claim 21, wherein said establishing includes determining whether each of said payout denominations from said plurality of gaming terminals is equally divisible into a maximum payout denomination of said payout denominations and, if the answer to said determining step is positive, setting said progressive-award denomination for each of said gaming terminals at a value that is equal to said maximum payout denomination.

23. The method of claim 21, further including establishing an escrow pool from a portion of said wager inputs at said plurality of gaming terminals.

24. The method of claim 23 wherein said escrow pool is equal to said maximum payout denomination.

25. (canceled)

26. The method of claim 23, wherein said escrow pool is equal to said progressive-award denomination.

27. (canceled)

28. (canceled)

29. (canceled)

30. (canceled)

31. The method of claim 21, wherein said progressive-award denomination is the same for each of said plurality of gaming terminal.

32. The method of claim 21, wherein said progressive-award denomination is greater than a lowest value of said payout denominations.

33. (canceled)

34. (canceled)

35. (canceled)

36. (canceled)

37. (canceled)

38. (canceled)

39. (canceled)

40. (canceled)

41. (canceled)

42. (canceled)

43. (canceled)

44. The method of claim 23, wherein the escrow pool is used to assist in paying said progressive jackpot if said progressive jackpot has an award value greater than an actual value of said progressive jackpot
